(19) United States
(12) Patent Application Publication
(10) Pub. No.: US 2025/0083559 A1
(43) Pub. Date: Mar. 13, 2025

(54) OUTDOOR POWER MACHINE CONTROL INTERFACE

(71) Applicant: Greenworks (Jiangsu) Co. Ltd., Changzhou (CN)

(72) Inventors: Christopher Eichel, Charlotte, NC (US); Paulius Bulovas, Jonkoping (SE); Jaquline Hultman, Huskvarna (SE)

(21) Appl. No.: 18/292,487

(22) PCT Filed: Sep. 15, 2022
(86) PCT No.: PCT/CN2022/118918

§ 371 Date: Jan. 26, 2024

(51) Int. Cl. B60L 58/10; A01D 34/66; A01D 34/78; A01D 101/00; B60K 1/02; B60K 1/04; B60L 15/20

(52) U.S. Cl. CPC B60L 58/10; A01D 34/78; B60K 1/02; B60K 1/04; B60L 15/20; A01D 34/66; A01D 2101/00; B60L 2200/40; B60L 2240/12; B60L 2250/16

(57) ABSTRACT

An outdoor power machine includes: a chassis; two or more drive wheel assemblies physically mounted to the chassis, each drive wheel assembly coupled to an electric motor; an electric power pack configured to supply electric energy to the electric motors; one or more steer wheels; and a user control panel including a touchscreen display configured to display one or more control elements and to control one or more functions of the outdoor power machine in response to user interaction with the one or more control elements.

### BACKGROUND OF THE INVENTION

This invention relates generally to outdoor power equipment, and more particularly to self-propelled outdoor power machines.

### BACKGROUND

Various types of outdoor power machines are known. Examples of common machines include lawn mowers and lawn tractors. Some outdoor power machines have an operator seat and are considered “ride-on”, “riders”, or “riding” machines. Others accommodate an operator in a standing position, described as a “stand-on” or “stander” machine.

Some known outdoor power machines are battery powered. They include a battery pack which provides electric power for the primary operating components of the machine, such as the drive wheels and mower deck or other powered implements. The battery pack also provides electric power for controls, displays, and accessories of the machine.

One problem with prior art outdoor power machines is that multiple physical controls must be provided to control multiple machine components and functions.

### BRIEF SUMMARY OF THE INVENTION

This problem is addressed by an outdoor power machine having an integrated control interface for multiple machine functions.

According to one aspect of the technology described herein, an outdoor power machine includes: a chassis; two or more drive wheel assemblies physically mounted to the chassis, each drive wheel assembly coupled to an electric motor; an electric power pack configured to supply electric energy to the electric motors; one or more steer wheels; and a user control panel including a touchscreen display configured to display one or more control elements and to control one or more functions of the outdoor power machine in response to us interaction with the one or more control elements.

### BRIEF DESCRIPTION OF THE DRAWINGS

The invention may be best understood by reference to the following description taken in conjunction with the accompanying drawing figures in which:

FIG. 1 is a front perspective view of an exemplary ride-on zero-turn outdoor power machine;

FIG. 2 is a rear perspective view of the machine of FIG. 1;

FIG. 3 is a side elevation view of the machine of FIG. 1;

FIG. 4 is a perspective view of a chassis of the machine of FIG. 1;

FIG. 5 is a front perspective view of an exemplary stand-on zero-turn outdoor power machine;

FIG. 6 is a rear perspective view of the machine of FIG. 5;

FIG. 7 is a side elevation view of the machine of FIG. 5;

FIG. 8 is a perspective view of a chassis of the machine of FIG. 5;

FIG. 9 is a perspective view of an exemplary mowing deck;

FIG. 10 is a bottom plan view of the mowing deck of FIG. 9;

FIG. 11 is a perspective view of a control panel of the machine of FIG. 1;

FIG. 12 is a view of a login screen displayed on a control panel;

FIG. 13 is in view of a home screen displayed on a control panel;

FIG. 14 is a view of a home screen displayed on a control panel;

FIG. 15 is a view of a home screen displayed on a control panel;

FIG. 16 is a view of a cutting session menu displayed on a control panel;

FIG. 17 is a view of a light menu displayed on a control panel;

FIG. 18 is a view of a settings menu displayed on a control panel;

FIG. 19 is a view of a language menu displayed on control panel;

FIG. 20 is a view of a statistics menu displayed on a control panel;

FIG. 21 is a view of an errors menu displayed on a control panel;

FIG. 22 is a view of error message displayed on a control panel; and

FIG. 23 is a perspective view of a control panel of the machine of FIG. 5.

### DETAILED DESCRIPTION OF THE INVENTION

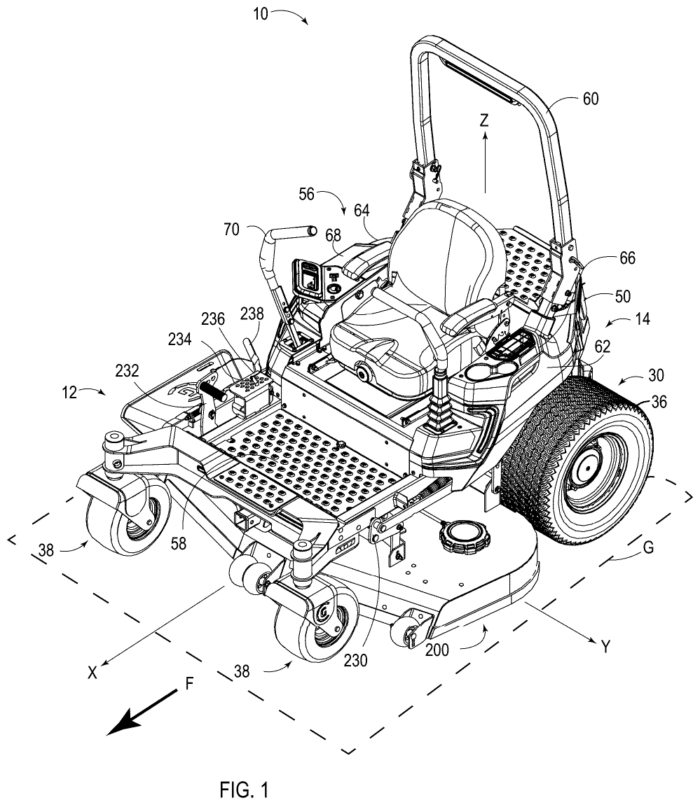

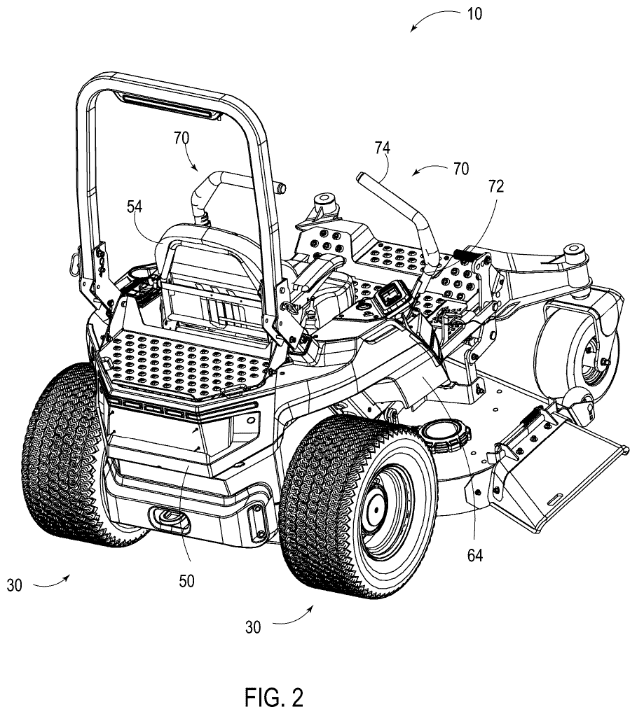

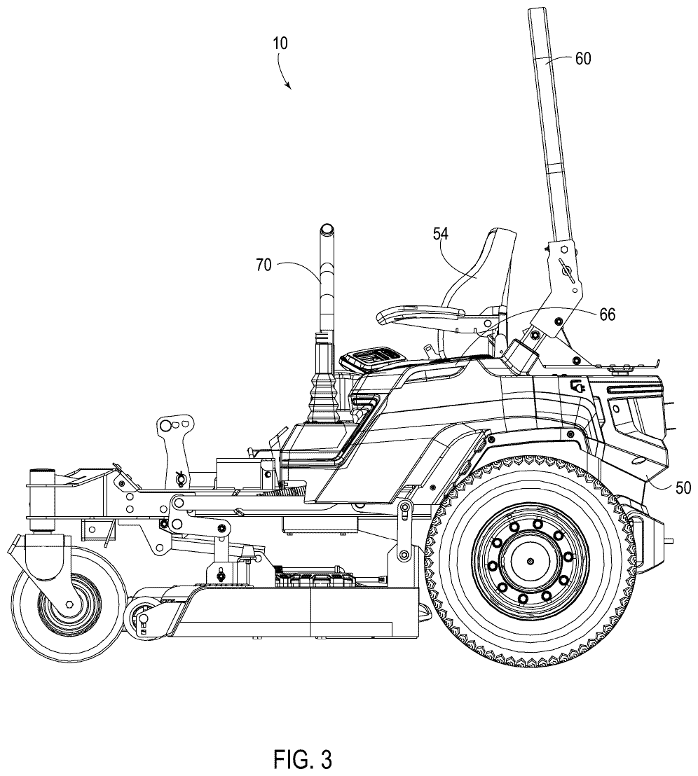

Referring to the drawings wherein identical reference numerals denote the same elements throughout the various views, FIGS. 1-3 show a representative embodiment of an outdoor power machine 10. The machine 10 extends along an axial direction (arrow “X”) between a front end 12 and a rear end 14. The points of contact of the wheels of the machine 10 collectively define a ground plane “G”.

It is noted that, as used herein, the terms “axial” and “longitudinal” both refer to a direction parallel to the axis X, while “vertical” refers to a direction perpendicular to the axial direction and to the ground plane G (see arrow “Z” in FIG. 1) and “lateral” refers to a direction mutually perpendicular to the axial and vertical directions (see arrow “Y” in FIG. 1). A primary forward direction of ground travel is shown by the arrow “F” in FIG. 1. These directional terms are used merely for convenience in description and do not require a particular orientation of the structures described thereby.

In the illustrated example, the outdoor power machine 10 is a zero-turn-radius type machine, alternatively referred to as a “zero-turn” machine. This type of machine is capable of changing its direction of travel (heading) without significant forward or backward movement. This is accomplished by differential rotation of drive wheels on opposite sides of the machine 10 to produce a yawing motion. For example, rotating the right-side wheel forward and simultaneously rotating the left-side wheel backward at the same wheel speed (RPM) will cause the machine 10 to yaw (turn) to the left without moving forwards or backwards. Related steering effects may be obtained by rotating drive wheels on opposite sides in different directions and different wheel speeds, by holding one wheel stationary while driving the opposite-side wheel in a chosen direction, or by rotating the wheels on opposite sides in the same direction at different wheel speeds.

The principles described herein are also applicable to a non zero-turn mower (not shown) using a conventional steering linkage to pivot (steer) some or all of the wheels.

In the example shown in FIGS. 1-3, the machine 10 is a ride-on machine (alternatively referred to as a “rider” or “riding machine”).

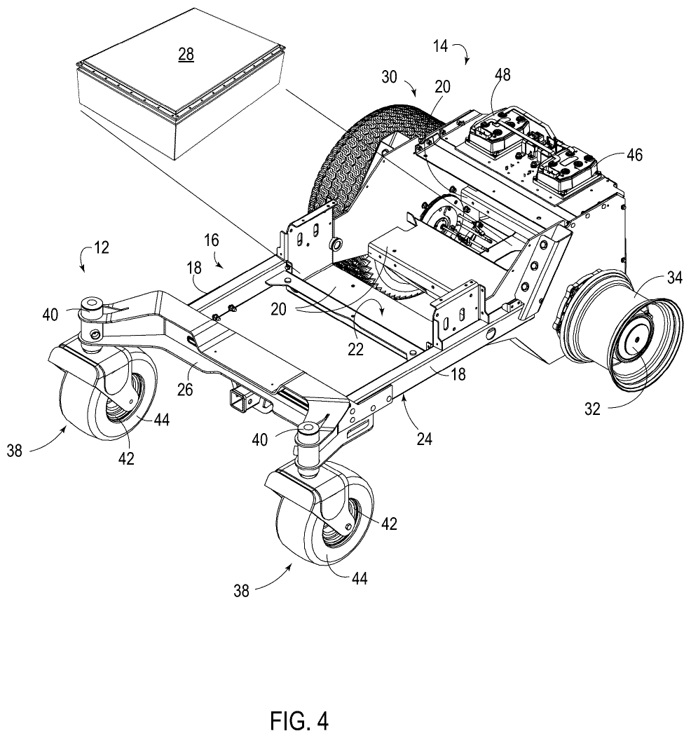

The machine 10 has a chassis 16 (FIG. 4) which provides structural support as well as mounting locations for the various components of the machine 10. Any material with adequate structural strength may be used to construct the chassis 16. Examples of suitable materials include metals such as aluminum and steel and their alloys. The chassis 16 may be monolithic or may be built up from smaller components, e.g., via fasteners, adhesives, or welding.

The chassis 16 includes a pair of spaced-apart main frame rails 18 extending in a longitudinal direction from the front end 12 of the machine 10 to the rear end 14 of the machine 10. Cross-members 20 interconnect the main frame rails 18. Top surfaces 22 of the cross-members 20 are positioned even with or lower than the bottom surfaces 24 of the main frame rails 18.

A front axle assembly 26 interconnects the main frame rails 18 at the front end 12 of the machine 10.

The machine 10 is equipped with an electric power pack 28 suitable for storing and discharging electric energy. In the illustrated example, the electric power pack 28 is a storage battery including one or more chemical cells, for example lithium ion cells. Other liquid battery chemistries may be substituted, as well as solid state batteries, capacitors, or similar devices which may exist currently or be later developed. The electric power pack 28 may include ancillary electric components such as inverters, transformers, voltage converters, relays, circuit breakers, and/or sensors. In the illustrated example, the electric power pack 28 includes at least one set of terminals providing a high voltage output (e.g. 82 V) for operating the primary components of the machine 10, such as the drive wheels and mower deck or other powered implement. It also includes another set of terminals providing a low voltage output (e.g. 12 V) for operating the control systems of the machine 10 as well as certain accessories.

The electric power pack 28 is positioned on the cross-members 20 and may be secured by fasteners, clips, latches, or the like (not shown).

The electric power pack 28 is positioned such that some portion of it is located at or below the bottom surfaces 24 of the main frame rails 18. Stated another way, the electric power pack 28 is positioned “between” the main frame rails 18, rather than sitting above or on top of the main frame rails 18.

The machine 10 is equipped with a drive wheel assembly 30, one on each side. Each drive wheel assembly 30 includes an integral drive hub 32 containing an internal electric motor, gear reduction drive, an optional brake (not separately illustrated), a drive wheel 34, and a tire 36 mounted to the drive wheel 34. It is noted that wheels having a ground-engaging surface, and thus not requiring a separate tire, are known in the art. The integral drive hub 32 is physically mounted to the chassis 16 such that the drive wheel 34 can rotate relative to the chassis 16. As will be described in further detail, the machine 10 is configured such that the wheel speed and direction of rotation can be controlled independently for the left- and right-side drive wheel assemblies 30. In the illustrated example, the drive wheel assemblies 30 are located at or near the rear end 14 of the machine 10. Alternatively, the drive wheel assemblies 30 could be located at or near the front end 12 of the machine 10.

The machine 10 is equipped with left- and right-side steer wheel assemblies 38. Each steer wheel assembly 38 includes a pivot assembly 40, a steer wheel 42, and a tire 44 mounted to the steer wheel 42. It is noted that wheels having a ground-engaging surface, and thus not requiring a separate tire, are known in the art. Each steer wheel assembly 38 is mounted to the chassis 16 such that the steer wheel 42 can rotate relative to the chassis 16 as well as pivot freely about an upright (vertical or near-vertical) axis. The steer wheel assemblies 38 function as casters and therefore passively steer the machine 10. As noted above, the principles described herein are also applicable to a non-zero-turn mower (not shown) using a conventional steering linkage to pivot (i.e., actively steer) some or all of the wheels.

The machine 10 is equipped with suitable electric connections, controls, and switching equipment to permit the operator to control the drive functions of the machine 10. In the illustrated example, the machine 10 includes a left drive motor controller 46 and a right drive motor controller 48. Each of these drive motor controllers 46, 48 includes an electric power connection to the electric power pack 28 as well as connections to operator controls as described below. Each drive motor controller 46, 48 is operable to receive a command signal from an operator control and to provide electric power to drive its associated drive wheel assembly 30 at the commanded wheel speed and direction.

The machine 10 includes a body 50 or superstructure positioned above the chassis 16. The body 50 functions to enclose the operating components of the machine 10, to provide the mounting structure for controls and accessories of the machine 10, and to provide a desired external appearance.

The body 50 includes a battery cover assembly 52 which encloses the electric power pack 28.

An operator seat 54 is mounted on top of the battery cover assembly 52. The operator seat 54 may be adjustable in one or more directions, may include retractable armrests, and may include a seatbelt or other restraint for the operator. The battery cover assembly 52 and the operator seat 54 collectively define an “operator station” 56 which functions to support the operator in a position with access to machine controls during operation.

A foot deck 58 is mounted to the chassis 16 forward of the battery cover assembly 52. This serves as a support for the operator's feet. As illustrated, it may be provided with a raised tread structure to increase traction and avoid slippage.

A rollover protection system (“ROPS”) 60 is mounted to the body 50 just aft of the operator seat 54. This is a hoop-like structure or rollbar which extends above the operator's head in the seated position. This functions to prevent injury to the operator should the machine 10 rollover in operation. In the illustrated example, the rollover protection system 60 can be folded down or removed to permit operations under low-hanging structures or vegetation, or to make the machine 10 more compact for transportation.

The body 50 includes left and right fenders 62, 64 respectively which flank the left and right sides of the operator seat 54. The left fender 62 is topped by a left console 66 and the right fender 64 is topped by a right console 68.

The body 50 carries one or more operator controls within reach of the operator seat 54. The primary operator controls include a pair of steering levers 70, one for the left side and one for the right side. Each steering lever 70 is generally L-shaped and includes a vertical section 72 pivotally mounted to the body 50 near the forward edge of the operator seat 54, and a horizontal section 74 which extends from the top of the vertical section 72 towards the centerline X of the machine 10.

Each steering lever 70 is pivotally mounted such that it can move in a fore-aft direction to control drive wheel speed. More specifically, the steering lever 70 is spring-loaded to a neutral position which commands drive wheel speed to stop and/or apply a brake. Movement in the forward direction away from the neutral position commands forward wheel rotation, with RPM proportional to steering lever deflection. Movement in the rearward direction away from the neutral position commands reverse wheel rotation, with RPM proportional to steering lever deflection.

Each steering lever 70 is further pivotally mounted so that it can move in a lateral direction between an outboard parking position and a inboard use position.

Optionally, the machine 10 may be equipped with parking switches (not illustrated) which are operable to detect if the steering levers 70 are in the outboard position or the inboard position. The parking switches may be configured such that the machine drive wheel assemblies 30 cannot be operated unless both steering levers 70 are pivoted to the inboard position.

Further controls can include one or more of the following: a key switch or other security device; a main power switch; an emergency stop control; a blade start/stop switch; a blade speed control; a drive speed limiter or cruise control; and lighting controls. These further controls may be mounted, for example to the left or right consoles 66, 68.

In the illustrated example, the right console 68 is provided with controls including a master power switch 69 (e.g. key switch or pushbutton start switch), a blade start/stop switch 71, and a user control panel 400.

The user control panel 400 is oriented so as to face directly or nearly directly to the user in operation. For example, it may be angled in one plane (e.g. tilted) such that a line normal to the control panel front face 402 is at a non-perpendicular, non-parallel angle to the console surface. It may also be angled in another plane (e.g. turned), such that the line normal to the control panel front face 402 is at a non-perpendicular, non-parallel angle to the centerline X of the outdoor power machine 10.

The user control panel 400 includes a touchscreen display 404 capable of displaying menus including graphics and/or text, and also accepting user inputs. For example it may be a resistive or capacitive touchscreen. The user control panel includes a bezel 406 surrounding the touchscreen display 404. Mounted in the bezel 406 are one or more hardware buttons 408. In the illustrated example, the hardware buttons 408 include a home button 410, an up button 412, and a down button 414. The function of these buttons is explained in more detail below.

The user control panel 400 physically incorporates or is operably connected to appropriate hardware such as one or more microprocessors programmed with appropriate software, to receive user commands and control one or more devices or systems within the outdoor power machine 10. For example, it may be provided with one or more switches or relays operable to open or close circuits to various functions of the outdoor power machine. As another example, it may be connected to one or more sensors carried on the outdoor power machine 10.

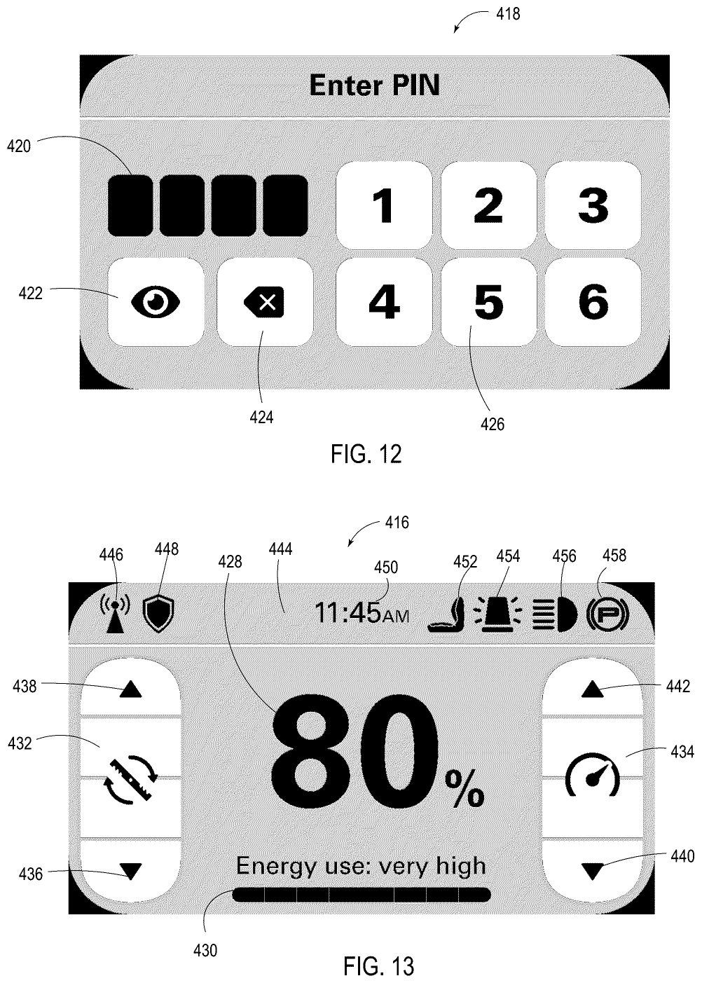

The touchscreen display 404 may be programmed to display a menu tree comprising a series of menus. Exemplary menus are illustrated in FIGS. 12-22.

In one example, pressing the home button 410 causes the touchscreen display 404 to display a main menu or “home screen” 416

In one example, pressing either the up button 412 or the down button 414 causes the touchscreen display 404 to cycle through a display of top-level menus.

The user control panel 400 may be used to record information relating to operation of the outdoor power machine 10. For example, it may store inputs from various sensors, switches, or controls of the outdoor power machine 10. This information may be displayed to the user on the touchscreen display 404.

The user control panel 400 may be used to control various functions of the outdoor power machine 10.

A user may interact with the menus using touchscreen inputs. It will be understood that the touchscreen display 404 has the capability to display control elements such as symbols, text, or icons which may represent physical switches or buttons, and that the touchscreen display 404 can be programmed to respond to a user's input in the form of close proximity, physical contact, and/or pressure within the boundaries of the displayed control elements by carrying out an appropriate command affecting a function of the outdoor power machine 10.

For simplicity of description, this interaction may be described as the user “pressing a button” on the touchscreen display or similar action. It will be understood that this refers to the user applying the aforementioned close proximity, physical contact, and/or pressure, within the boundaries of the indicated control element.

FIG. 12 illustrates a login menu 418. This includes number entry fields 420, a “show digits” button 422, a delete/backspace button 424, and numeric entry keys 426. This login menu 418 may be presented initially in response to any attempted user input, such as pressing one of the hardware buttons 408 or touching the touchscreen display 404. The outdoor power machine 400 may be programmed with a password or personal identification number (“PIN”). The user control panel 400 may be programmed such that the user must input the proper PN in order to access any other functions of the outdoor power machine 10.

Once access has been gained to the touchscreen display 404 using the login menu 418, or the touchscreen display 404 has been otherwise activated, it may display a home screen 416 as shown in FIG. 13 by default. The home screen 416 includes a battery charge percentage indicator 428, an energy use rate indicator 430, a blade speed control 432, and a drive speed control 434.

The blade speed control 432 serves as a combined display and control element. It includes a bar graph displaying blade speed from stop (lowest position) to maximum speed (highest position). It also includes, overlaid on the bar graph area, a decrease speed icon 436 and an increase speed icon 438. Applying a touch input to the decrease speed icon 436 or the increase speed icon 438 decreases or increases the speed of the blade motors. In the illustrated example, the bar graph is at its highest position indicating maximum blade speed.

The drive speed control 434 serves as combined a display and control element. It includes a bar graph displaying maximum machine speed from stopped (lowest position) to maximum possible speed (highest position). It also includes, overlaid on the bar graph area, a decrease speed icon 440 and an increase speed icon 442. Applying a touch input to the decrease speed icon 440 or the increase speed icon 442 decreases or increases the maximum speed of the drive wheel assemblies 30, as controlled by the steering levers 70. In the illustrated example, the bar graph is at its highest position indicating maximum possible drive speed will be obtained with the steering levers 70 moved to the maximum deflection.

The home screen 416 may include a notification bar 444 that may display various icons at various times to communicate the status of the outdoor power machine 10. In the illustrated example, the notification bar 444 shows icons from left to right including: a wireless signal strength indicator 446, a tracking network availability indicator 448, a clock 450, an operator present icon 452, a visibility lighting icon 454, a work lighting icon 456, and a parking brake/park mode indicator 458.

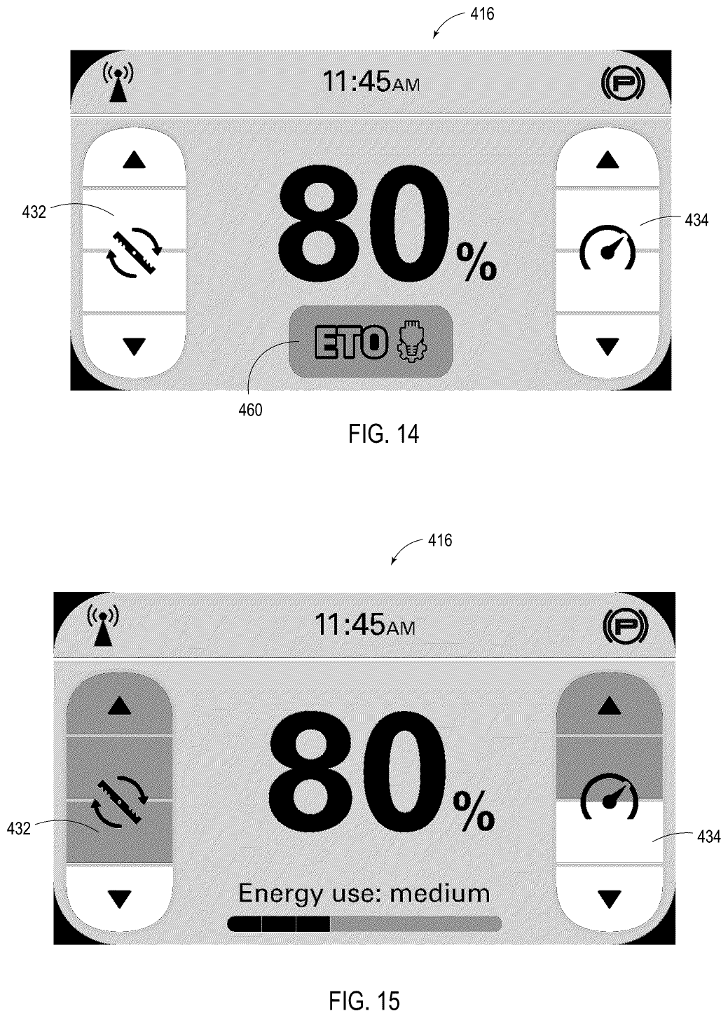

The home screen 416 serves as a basic indicator of status of the power machine. The home screen 416 may change the information displayed to indicate various major parameters and statuses of the outdoor power machine 10. For example, in FIG. 14, the home screen 416 has an ETO icon 460 illuminated, indicating that an electrically powered power takeoff system of the outdoor power machine 10 (not separately illustrated) is operating. In another example, shown in FIG. 15, the home screen 416 has the blade speed control 432 showing the blade motors operating at approximately 25% of maximum, and the drive speed control showing the maximum drive speed of the outdoor power machine 10, as controlled by steering levers 70, at approximately 50% of the maximum possible.

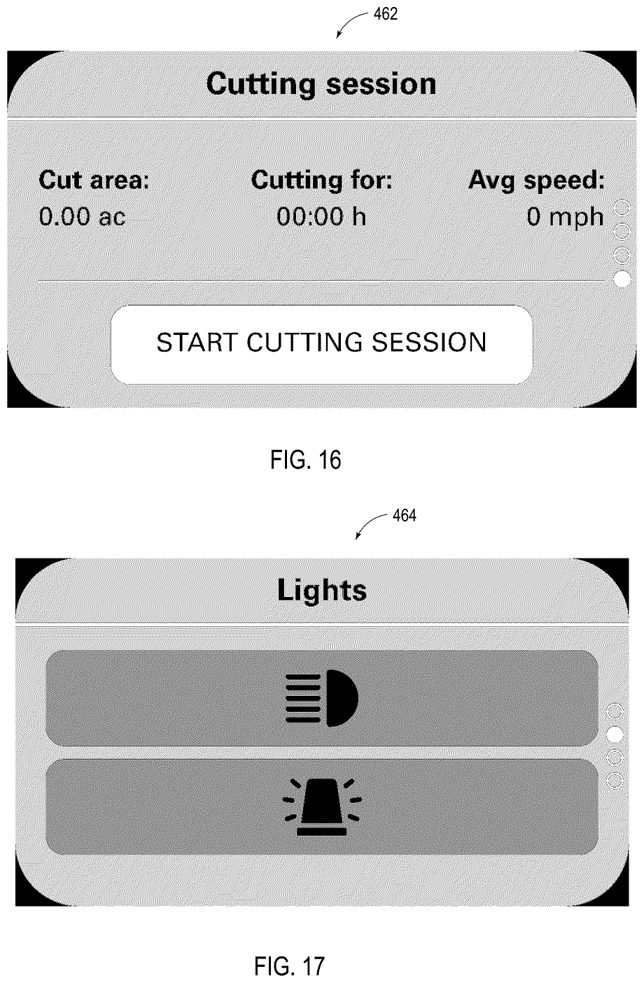

FIG. 16 shows a cutting session screen 462, which is one possible top-level menu screen. This may be accessed by pressing one of the hardware buttons 412 or 414 described above. The cutting session screen 462 display statistics about the current cutting session, and includes appropriate touchscreen icons for starting, stopping, and/or resetting the session.

FIG. 17 shows a light control screen 464, which is one possible top-level menu screen. This may be accessed by pressing one of the hardware buttons 412 or 414 described above. It includes appropriate touchscreen icons for activating or deactivating lighting systems of the outdoor power machine 10.

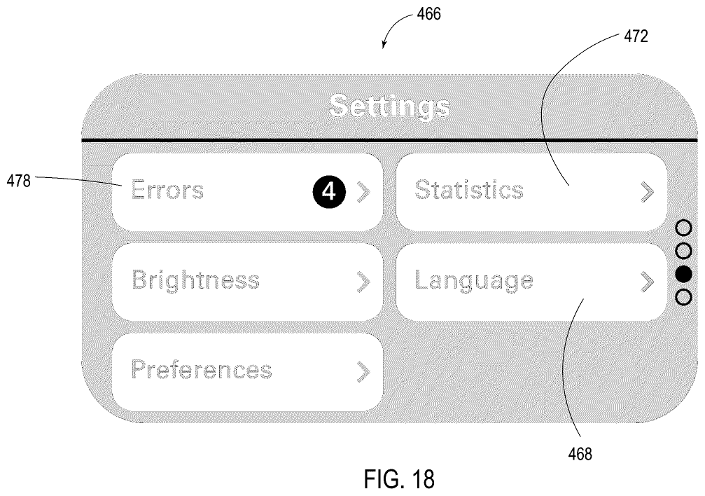

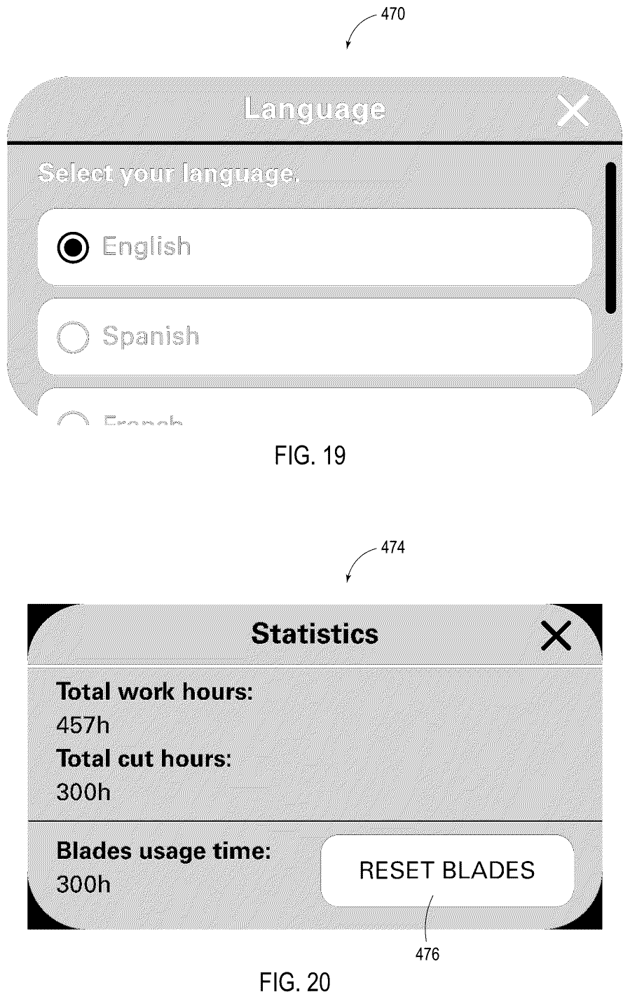

FIG. 18 shows a settings control screen 466, which is one possible top-level menu screen. This may be accessed by pressing one of the hardware buttons 412 or 414 described above. It includes appropriate touchscreen icons for viewing and/or changing operational settings of the outdoor power machine 10. One or more of the touchscreen icons may activate one or more sub-menus. For example, a language icon 468 may activate a language menu 470, shown in FIG. 19, which includes appropriate touchscreen icons for changing the language of the menus.

As another example, a statistics icon 472 activates a statistics menu 474, shown in FIG. 20. The statistics menu 474 shows various statistical information relating to the operation of the outdoor power machine 10, such as the total machine operating hours, and the total number of hours of mowing. In this example, there is a separate display of the blade usage time relating to a particular set of mowing blades. This may be reset using the reset icon 476. The statistics menu 474 is useful for determining the overall condition of the outdoor power machine 10, as well as predicting the need for maintenance and/or replacement of components. For example, when a particular set of mowing blades is operated for a predetermined number of hours, they may be sharpened and/or replaced to ensure acceptable cut quality.

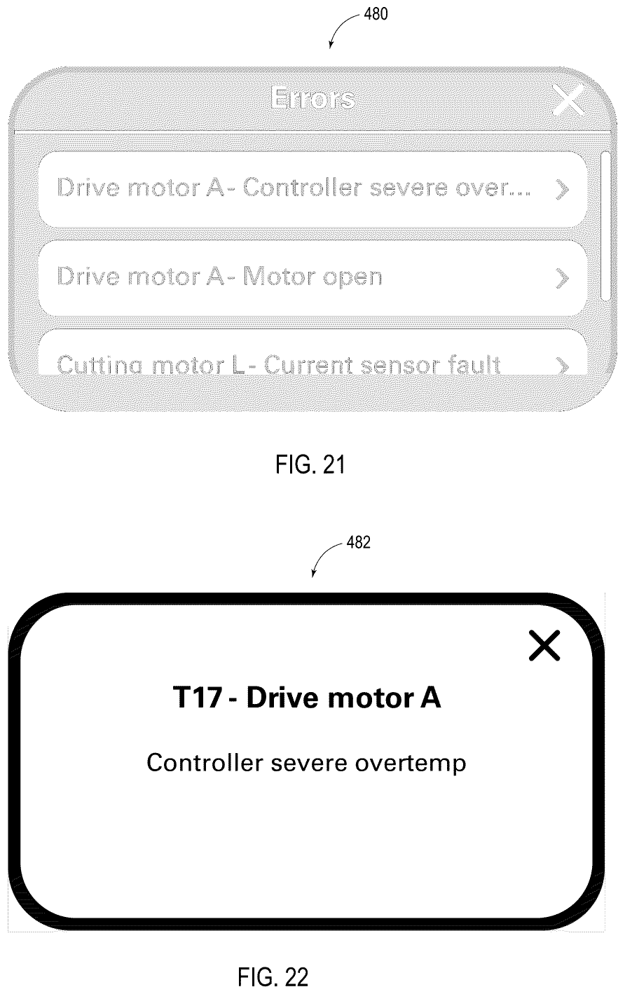

As another example, an error icon 478 activates an error menu 480, shown in FIG. 21. This shows a list of error messages that have been triggered during operation of the outdoor power machine 10. The messages can be individually accessed to obtain more information. For example, FIG. 22 illustrates a process error message 482 indicating the drive motor A has incurred a controller severe over temp. This information may lead the user to stop the outdoor power machine 10, inspect it, and repair or replace various components.

The outdoor power machine 10 may be used as follows. First, the operator sits in the operator seat 54 and activates the main power switch 69, or optionally activates the machine 10 through the login menu 418 on the user control panel 400. A blade start/stop switch 71 is used to turn on mowing blades or other powered implement, and the implement is adjusted to an operating position, such as a desired cutting height for mowing. The steering levers 70 are moved from the outboard parking position to the inboard use position. The operator then uses the steering levers 70 to drive the outdoor power machine 10 in the desired direction while mowing or other implement operation takes place. It will be understood from the above description that manipulation of the steering levers 70 is sufficient to control forward and aft movement of the outdoor power machine 10, as well as braking and steering. Other aspects of operation, such as blade speed, drive speed, and detailed machine settings, may be controlled through the user control panel 400 described above.

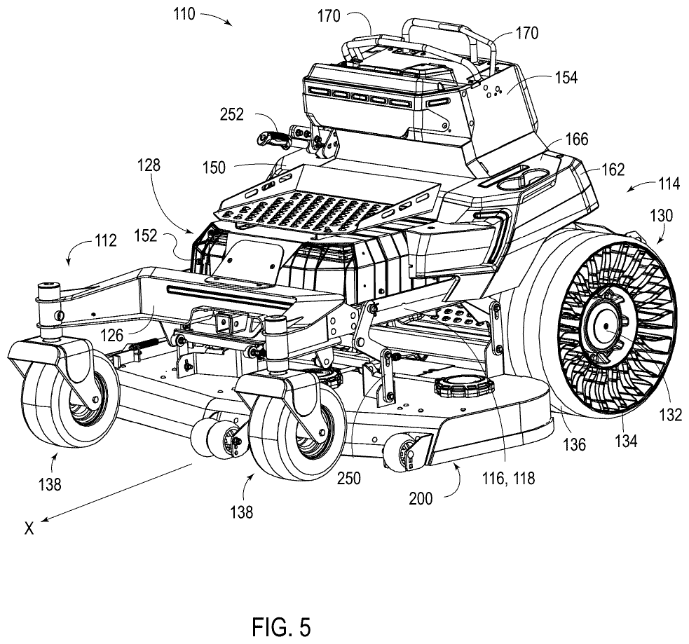

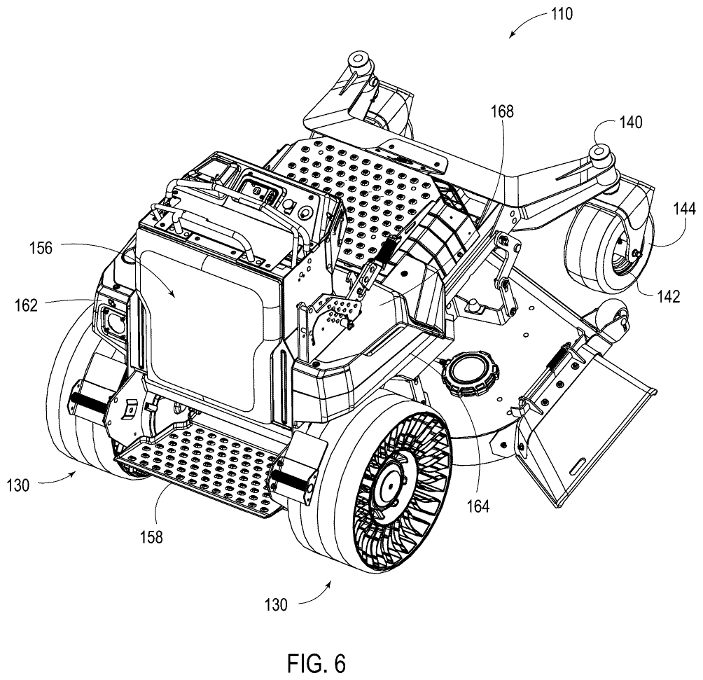

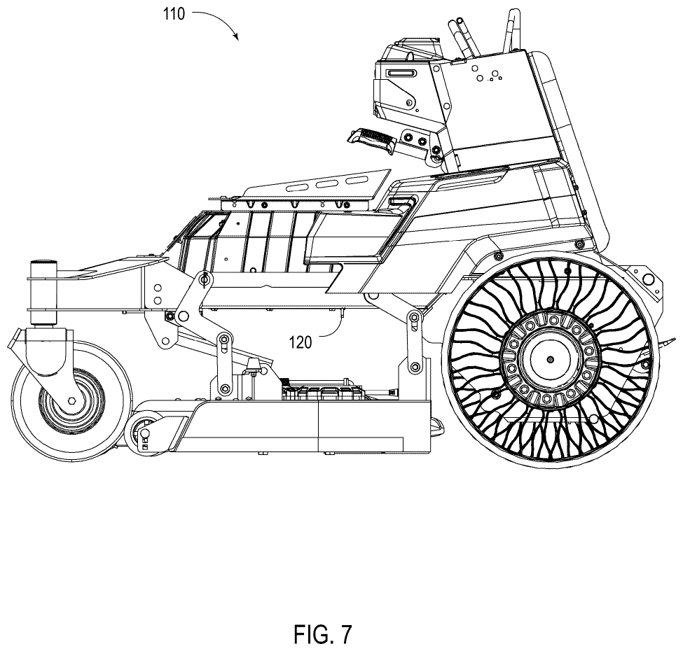

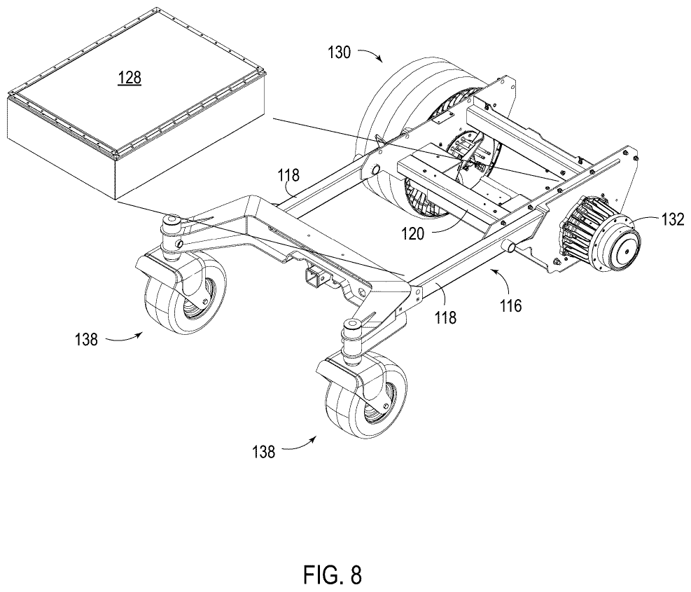

FIGS. 5-8 illustrate another exemplary embodiment of an outdoor power machine 110. This embodiment of the machine 110 is a stand-on machine (alternatively referred to as a “stander”). The overall construction of the machine 110 is similar to the machine described above. Elements of the machine 110 not explicitly described may be taken to be identical to the machine 110 described above.

The machine 110 has a chassis 116 including main frame rails 118 extending in a longitudinal direction from a front end 112 of the machine 110 to a rear end 114 of the machine 110. Cross-members 120 interconnect the main frame rails 118. A front axle assembly 126 interconnects the main frame rails 118 at the front end 112 of the machine 110.

The machine 110 is equipped with an electric power pack 128 as described above.

The machine is equipped with left- and right-side drive wheel assemblies 130. Each drive wheel assembly 130 includes an integral drive hub 132 containing an electric motor, a gear reduction drive, and an optional brake (not separately illustrated), a drive wheel 134, and a tire 136 mounted to the drive wheel 134. It is noted that wheels having a ground-engaging surface, and thus not requiring a separate tire, are known in the art. In the illustrated example, the drive wheel assemblies 130 are located at or near the rear end 114 of the machine 110. Alternatively, the drive wheel assemblies 130 could be located at or near the front end 112 of the machine 110.

The machine 110 is equipped with left- and right-side steer wheel assemblies 138. Each steer wheel assembly 138 includes a pivot assembly 140, a steer wheel 142, and a tire 144 mounted to the steer wheel 142. It is noted that wheels having a ground-engaging surface, and thus not requiring a separate tire, are known in the art. Each steer wheel assembly 138 is mounted to the chassis 116 such that the steer wheel 142 can rotate relative to the chassis 116 as well as pivot freely about an upright (vertical or near-vertical) axis. The steer wheel assemblies 138 function as casters and therefore passively steer the machine 110. As noted above, the principles described herein are also applicable to a non zero-turn mower (not shown) using a conventional steering linkage to pivot (i.e., actively steer) some or all of the wheels.

The machine 110 is equipped with suitable electric connections, controls, and switching equipment to permit the operator to control the drive functions of the machine 110. In the illustrated example, the machine 110 includes a left drive motor controller and a right drive motor controller (not visible in the drawings). Each of these drive motor controllers includes a electric power connection to the electric power pack 128 as well as connections to operator controls as described below. Each drive motor controller is operable to receive a command signal from an operator control and to provide electric power to drive its associated drive wheel assembly 130 at the commanded wheel speed and direction.

The machine 110 includes a body 150 or superstructure positioned above the chassis 116.

The body 150 includes a battery cover assembly 152 which encloses the electric power pack 128. A control pedestal 154 is mounted on top of the battery cover assembly 152.

A foot deck 158 is mounted to the chassis 116 aft of the battery cover assembly 152. This serves as a support for the operator's feet. As illustrated, it may be provided with a raised tread structure to increase traction and avoid slippage. The battery cover assembly 152, the control pedestal 154, and the foot deck 158 collectively define an “operator station” 156 which functions to support the operator to provide access to machine controls during operation.

The body 150 includes left and right fenders 162, 164 respectively which flank the left and right sides of the control pedestal 154. The left fender 162 is topped by a left console 166 and the right fender 164 is topped by a right console 168.

The body 150 carries one or more operator controls within reach of the operator station 156. The primary operator controls include a pair of steering levers 170, one for the left side and one for the right side. Each steering lever 170 is generally L-shaped and includes a vertical section pivotally mounted to the control pedestal 154, and a horizontal section which extends from the top of the vertical section towards the centerline X of the machine 110. Each steering lever 170 is pivotally mounted such that it can move in a fore-aft direction to control drive wheel speed as described above.

Each steering lever 170 is further pivotally mounted so that it can move in a lateral direction between an outboard parking position and a inboard use position. Optionally, the machine 110 may be equipped with parking switches as described above.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the control pedestal 154 or to the left or right consoles 166, 168.

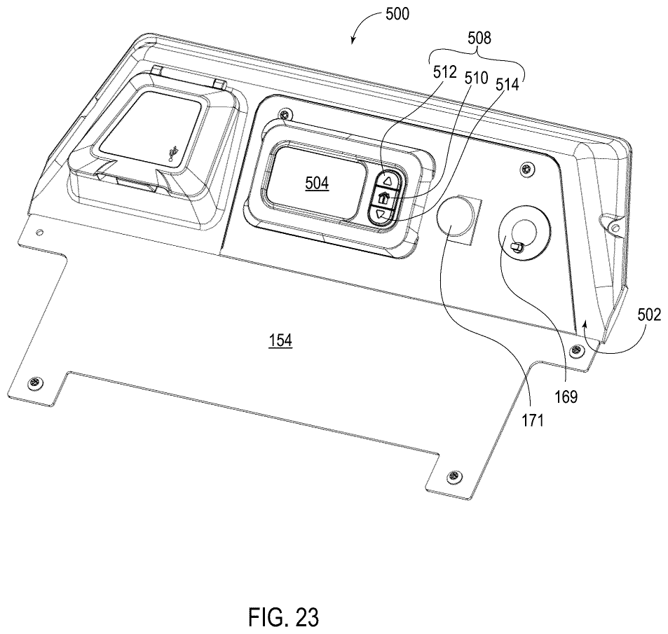

In the illustrated example, see FIG. 23, the control pedestal 154 is provided with controls including a master power switch 169 (e.g. key switch or pushbutton start switch), a blade start/stop switch 171, and a user control panel 500.

The user control panel 500 is oriented so as to face directly or nearly directly to the user in operation. For example, it may be angled in one plane (e.g. tilted) such that a line normal to the control panel front face 502 is at a non-perpendicular, non-parallel angle to the console surface.

The user control panel 502 includes a touchscreen display 504 capable of displaying menus including graphics and/or text, and also accepting user inputs. For example it may be a resistive or capacitive touchscreen. The user control panel includes a bezel 506 surrounding the touchscreen display 504. Mounted in the bezel 506 are one or more hardware buttons 508. In the illustrated example, the hardware buttons 508 include a home button 510, an up button 512, and a down button 514.

The function of the user control panel 500 including the hardware buttons 508 and the touchscreen display 504 is substantially identical to corresponding elements of the user control panel 400 as described above.

Any of the outdoor power machines described herein may be may be equipped with one or more implements, defined generally as a device attached to or carried by the machine and operable to cut, shape, load, lift, move, or transport material. Nonlimiting examples of implements include mowing decks, plows, disks, scarifiers, rippers, aerators, dethatchers, blades, buckets, scrapers, or blowers.

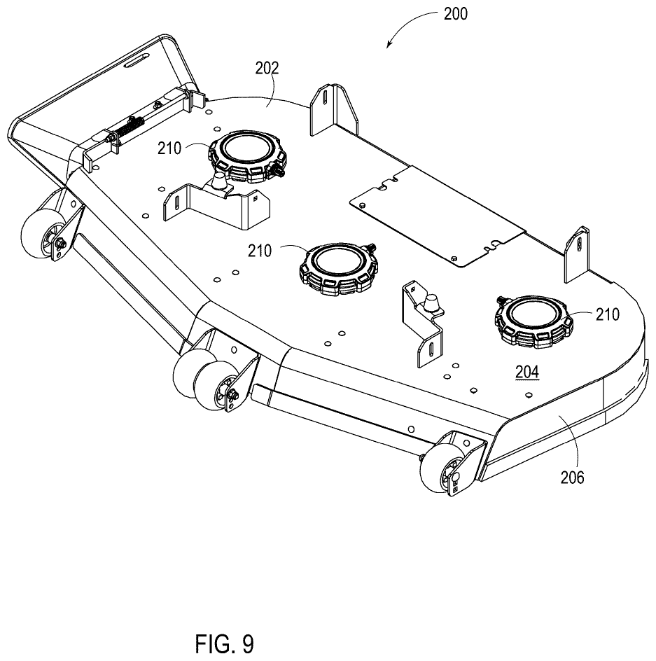

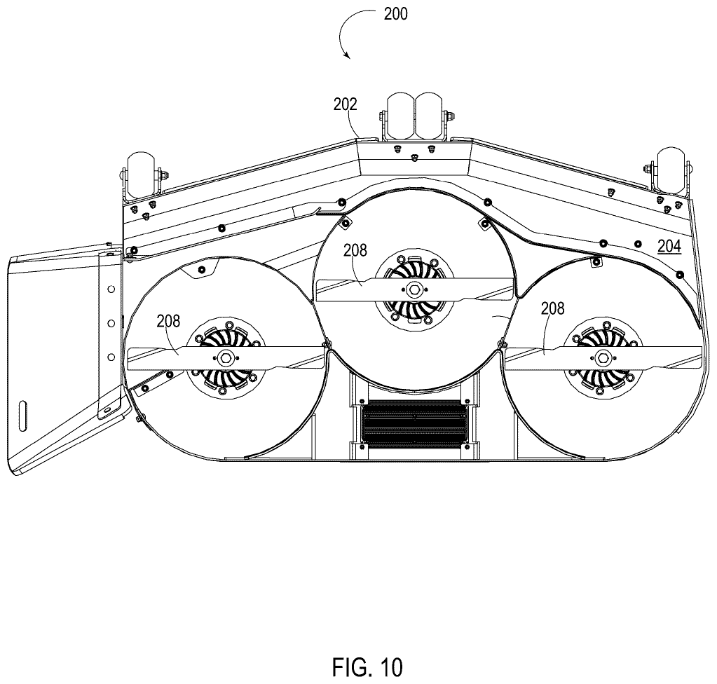

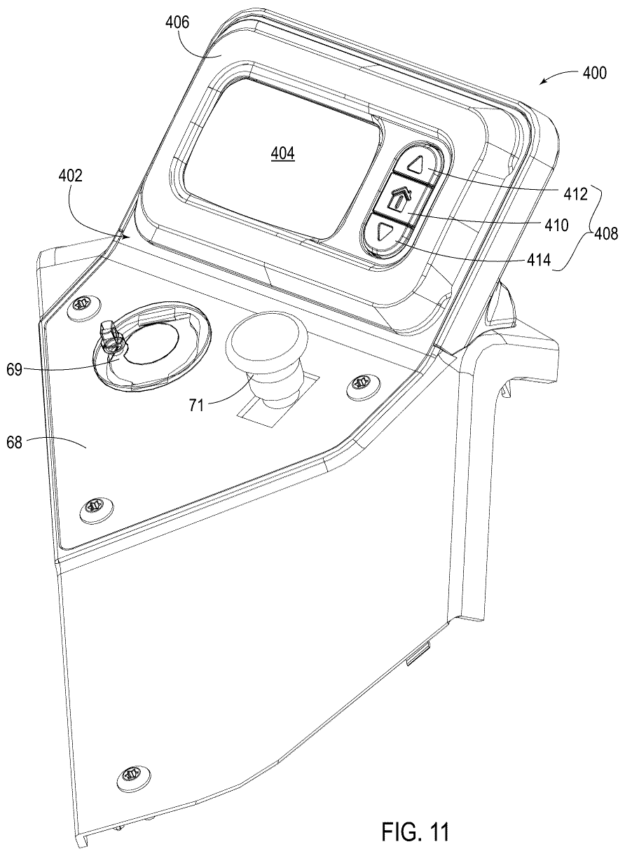

In the illustrated example, the machine 10 or 110 is equipped with a mowing deck assembly 200 (FIGS. 9, 10). It includes a deck 202 which is an open-bottomed enclosure including a top panel 204 and a peripheral wall 206.

The deck 202 has a nominal designated width which may be selected to provide a desired cutting swath. Non-limiting examples of suitable deck widths include 48 inches, 52 inches, 60 inches, or 72 inches.

One or more mowing blades 208 are rotatably mounted on the underside of the top panel 204. The mowing blades 208 are positioned in a side-by side configuration such that their tips will not collide in operation. The mowing blades 208 may be positioned to have some overlap in at least one dimension so as to prevent un-mowed strips during mower operation. The dimensions of the individual mowing blades 208 are selected to provide adequate structural strength at selected operating speed, (e.g. 3600 RPM). Generally, the size of the individual mowing blades 208 is equal to the deck width divided by the number of mowing blades 208, with some additional diameter provided to accommodate for swath overlap. For example, a deck 202 having a nominal width of 60 inches may use three mowing blades 208 each having a diameter of 20.5 inches.

Means are provided for driving the mowing blades 208. Nonlimiting examples of suitable drive methods include mechanical, hydraulic, or electric devices. In the illustrated example, each mowing blade 208 is directly driven by its own individual electric blade motor 210.

The mowing deck assembly 200 is connected to the chassis via a deck lift. The deck lift is operable to position the mowing blades 208 at a preselected distance above the ground plane G of the machine. Typical examples include a cutting height in the range of approximately 1 inch to approximately 6 inches. The deck lift is also operable to lift the mowing deck assembly 200 well above any intended cutting height so that the machine can traverse obstacles, travel along a road to a worksite, or be loaded or unloaded from a trailer or storage building. This is referred to as a “travel position”.

In the example shown in FIGS. 1-4, a deck lift 230 includes a foot pedal 232 to raise the deck lift 230. A removable pin 234 is insertable into a selected hole in a blade height adjuster 236. The position of the pin 234 determines a cutting height by blocking the deck lift 230 at a specific position. An uplock lever 238 is provided to selectively lock and release the deck lift 230 in the travel position.

In the example shown in FIGS. 5-8, the mowing deck assembly 200 is connected to the chassis 116 via a deck lift 250. The deck lift 250 is similar to the deck lift 230 described above, the primary difference being that is operated by a hand lever 252 as opposed to a pedal.

The machine described herein has advantages over prior art machines. The unified control interface provides control over multiple machine functions in one compact unit which can replace multiple discrete switches and which can easily be reused for different machines.

The foregoing has described an outdoor power machine. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An outdoor power machine, comprising:
a chassis;
two or more drive wheel assemblies physically mounted to the chassis, each drive wheel assembly coupled to an electric motor;
an electric power pack configured to supply electric energy to the electric motors;
one or more steer wheels; and
a user control panel including a touchscreen display configured to display one or more control elements and to control one or more functions of the outdoor power machine in response to us interaction with the one or more control elements.

2. The outdoor power machine of claim 1, wherein the touchscreen display is configured to display the one or more control elements embodied in a menu tree including one or more menu screens.

3. The outdoor power machine of claim 2, wherein the menu tree includes two or more top-level menu screens.

4. The outdoor power machine of claim 1, wherein the user control panel includes one or more hardware buttons.

5. The outdoor power machine of claim 1, wherein the user control panel includes one or more hardware buttons and the touchscreen display is configured to display selected ones of two or more top level menu screens in response to operation of the one or more hardware buttons.

6. The outdoor power machine of claim 1, where the touch screen display is configured to display the one or more control elements embodying in a menu tree including one or more menu screens, the menu tree including a home screen which includes a battery charger status indicator.

7. The outdoor power machine of claim 6, wherein the user control panel includes a hardware button designated as a home button, and the touch screen display is configured to display the home screen in response to activation of the home button.

8. The outdoor power machine of claim 1, wherein at least one of the control elements is a combined display and control element.

9. The outdoor power machine of claim 8, wherein the combined display and control element is configured as a bar graph.

10. The outdoor power machine of claim 1, wherein the touchscreen display is configured to display a drive speed control and is responsive to set a maximum speed of the two or more drive wheel assemblies in response to operation of the drive speed control.

11. The outdoor power machine of claim 1, further including a mowing deck assembly, including:
a mowing deck;
an electric blade motor; and
a cutting blade coupled to the blade motor.

12. The outdoor power machine of claim 11, wherein the touchscreen display is configured to display a blade speed control and is responsive to set a speed of the electric blade motor in response to operation of the blade speed control.

13. The outdoor power machine according to claim 12, wherein the mowing deck includes two or more electric blade motors, and the blade speed control is responsive to set a speed of the two or more electric blade motors.

14. The outdoor power machine of claim 1, further including an operator station, wherein the user control panel is angled so as to face a user standing or seated in the operator station.

15. The outdoor power machine of claim 14, wherein the user control panel is oriented at a non parallel, non-perpendicular angle from a vertical direction and is also angled at a non-parallel, non-perpendicular angle from a longitudinal centerline of the chassis.

16. The outdoor power machine according to claim 1, wherein the touchscreen display is configured to display at least one operating statistic of the outdoor power machine.

17. The outdoor power machine of claim 1, further including a standing platform for an operator.

18. The outdoor power machine of claim 1, further including a seat for an operator.
